(19) United States
(12) Patent Application Publication
(10) Pub. No.: US 2003/0208685 A1
(43) Pub. Date: Nov. 6, 2003

(54) Multi-platform application installation

(76) Inventor: Hassan E. Abdel-Rahman, Broomfield, CO (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/138,077

(22) Filed: May 1, 2002

(51) Int. Cl. G06F 11/30; G06F 9/445; G06F 9/44

(52) U.S. Cl. 713/191; 717/174; 717/168

(57) ABSTRACT

Disclosed are novel methods and apparatus for provision of multi-platform, efficient, and/or lightweight software product installation. In an embodiment, a method of configuring a software installer is disclosed. The method includes: launching the software installer; receiving a request to launch a file while the software installer is running; the software installer accessing an application launch facility to determine a launching command for launching the file; executing the launching command to obtain an installation key; and the software installer installing a software product based on data provided by the installation key.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright® 2002, Sun Microsystems, Inc., All Rights Reserved.

### FIELD OF INVENTION

The present invention generally relates to the field of software installation. More specifically, an embodiment of the present invention provides a multi-platform, efficient, and lightweight installation solution, for example, for installing software applications on a computer system.

### BACKGROUND OF INVENTION

In today's computer systems, applications are generally utilized to manipulate data. For example, a Web browser can enable a user to access data on the Internet. The data may include text, graphics, video, sound, and the like. To provide access to an application, that application must first be installed on either a stand-alone computer, or a server accessible through a network, for example. Today's installer applications, however, often require users to close all other running applications before the installation can proceed. One reason for such restriction is to ensure that the installer does not face any shortage of computer resources.

This restriction, however, limits software designers in that information displayed to users during the installation will have to be incorporated into the installer application. This approach not only limits a software engineer who is designing an installer, but also extends the period for designing such installers. More specifically, the installer code will have to include not only the installation code, but also the data and code for displaying the desired information during the installation.

The problems associated with the prior art are exasperated even more for multi-platform installers. In particular, when a software engineer is designing a multi-platform installation product (i.e., an installer that can install an application on multiple platforms), he/she will have to take into account unique implementation issues associated with launching other applications during the installation. For example, launching an external application while installing a software program on a computer running a UNIX operating system may require different commands than launching the respective version of the external application in the Microsoft Windows environment.

### SUMMARY OF INVENTION

The present invention, which may be implemented utilizing a general-purpose digital computer, in certain embodiments, includes novel methods and apparatus to provide efficient and/or lightweight software installation. In an embodiment, a method of configuring a software installer is disclosed. The method includes: launching the software installer; receiving a request to launch a file while the software installer is running; the software installer accessing an application launch facility to determine a launching command for launching the file; executing the launching command to obtain an installation key; and the software installer installing a software product based on data provided by the installation key.

In a further embodiment, a method of installing a software application is disclosed. The method includes: launching an application installer to install the software application; while the application installer is installing the software application, receiving information about a file to launch during the installation of the software application; determining a launching application that can launch the file; requesting a launching command from an operating system, the application installer running on the operating system; and launching the application to open the file.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which the present invention may be embodied;

FIG. 2 illustrates an exemplarily block diagram of an installation method 200 in an accordance with an embodiment of the present invention; and

FIG. 3 illustrates an exemplarily installer configuration method 300 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

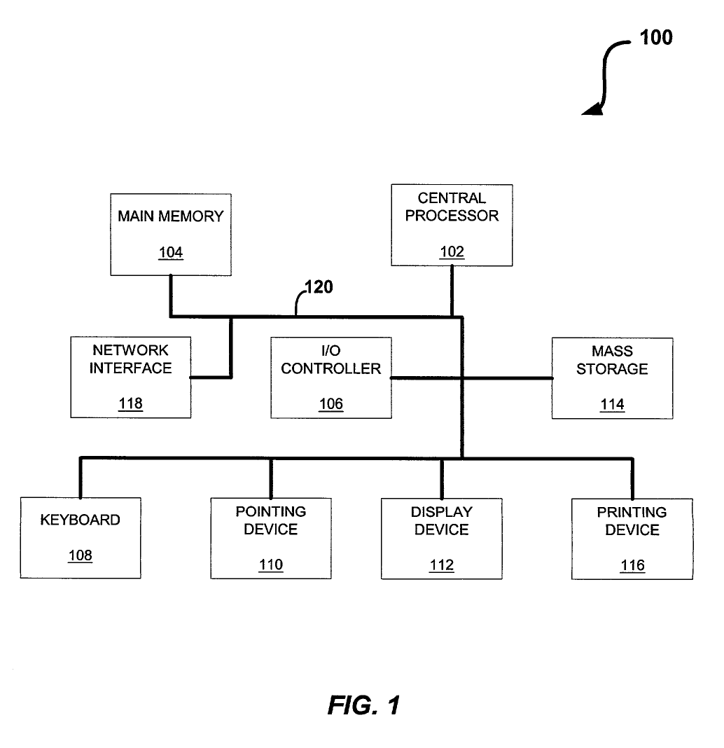

FIG. 1 illustrates an exemplary computer system 100 in which the present invention may be embodied in certain embodiments. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In an embodiment, the computer system 100 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments, the network interface 118 can be implemented utilizing technologies including, but not limited to, Ethernet, Fast Ethernet, wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HPUX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments, the computer system 100 is a general purpose computer capable of running any number of applications such as those available from companies including Oracle, Siebel, Unisys, Microsoft, and the like.

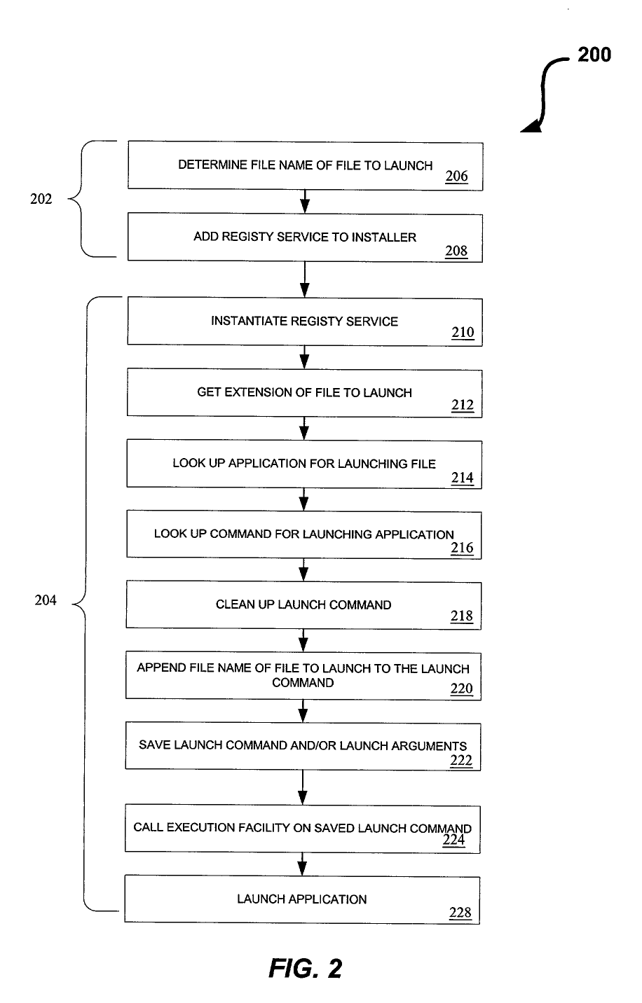

FIG. 2 illustrates an exemplarily block diagram of an installation method 200 in an accordance with an embodiment of the present invention. The installation method 200 includes a set of installer build steps 202 and installer execution steps 204. The installer built steps 202 includes a step 206 which determines the file name of a file to be launched. In an embodiment, this file information may be embedded in the installer being built. In a step 208, a registry service is added to the installer. It is envisioned that the registry service added may depend on the operating system utilized for the application being installed. For example, in a Windows environment, the registry service may be Win32. Similarly, in the Solaris environment, the registry service may be the common desktop environment (CDE), and in a Mac OS, it may be the launch services.

In a step 210 (the first step of the installer execution steps 204), the registry service of the step 208 is instantiated. A step 212 determines the extension of the filed of the step 206 to be launched. A step 214 looks up the value or identity of the appropriate application for launching the file of the step 206, for example, based on the determined extension of the step 214 (e.g., the application that is identified by the registry service of the step 208 for launching the file of the step 206). For example, in the Windows environment, the step 214 would look up the default value of the HKEY_CLASSES_ROOT\.XYX in the Win32 registry. In an embodiment, the step 214 is envisioned to yield the application name (e.g., ApplicationX).

A step 216 looks up the value or command for opening the application identified by the step 214, for example, with reference to the registry service of the step 208. For example, in the Windows environment, the step 214 would look up the default value for the HKEY_CLASSES_ROOT\ApplicationX\shell\open\command utilizing the registry service of the step 208. The step 216 is envisioned to yield the launch command (e.g., launch.exe). In a step 218, the launch command is cleaned up, for example, by removing quotes and/or extraneous variables (such as DOS variables that may be present in a Windows environment embodiment). In a step 220, the file name of the file to launch is appended to the launch command (e.g., by appending the file name of the step 206 to the launch command of the step 216 and/or 218).

In a step 222, the launch command and the appropriate launch arguments are saved (optional), for example, to a property. In an embodiment, the property is generally considered as a temporary placeholder for the complete launch command. A step 224 calls the execution facility on the saved launch command or property containing the launch command (and where applicable launch arguments). For example in the Windows environment, the execution facility may be the execution wizard. In a step 226, the actual application is launched which, for example, can in turn display the file determined in the step 206.

Accordingly, the installation method 200, in an embodiment, may provide for a multi-platform solution for building and executing an installation program capable of launching files which need to run through an external application program. In this fashion, the installation method 200 may avoid requiring a software engineer to take every unique implementation issue associated with launching other applications during the installation process, especially for a multi-platform installation solution. Also, such embodiments may reduce the period required for designing multi-platform installers.

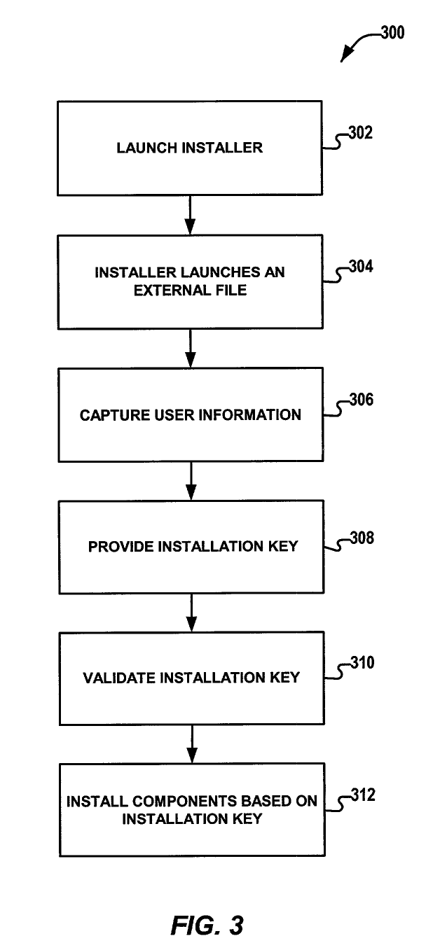

FIG. 3 illustrates an exemplarily installer configuration method 300 in accordance with an embodiment of the present invention. The installer configuration method 300 in a step 302 launches an installer. It is envisioned that the installer may be launched by a user or alternatively automatically, for example, via a timer or by other computer applications. In a step 304, the launched installer may launch an external file such as a hypertext markup language (HTML) page by, for example, utilizing a Web browser (such as the Internet Explorer available from Microsoft Corporation of Redmond, Wash., and Netscape Navigator available from various sources including iPlanet, now a division of Sun Microsystems, Inc., of Palo Alto, Calif.). In an embodiment, it is envisioned that the step 304 may be performed by utilizing the steps discussed with respect to FIG. 2.

In a step 306, the launched HTML page(s) of the step 304 may require a user to provide information about the user. In an embodiment, the user information may include a unique identifying indicia (e.g., a serial number, authorization number, etc.), contact information (such as address, name, phone number, etc.), operating system used, preferred language, and the like. Based on the captured information in the step 306, an installation key may be provided in a step 308. In one embodiment, the installation key is envisioned to include information utilized by the installer to provide an appropriate set of features for the application being installed. For example, the user may request that features from multi-user application installation be utilized, a less resource intensive version of the application be installed (for example, for a portable and/or handheld device), duration of the application being accessible (for example, where a user may only want to utilize a tax software for a month before the tax filing deadline), the application to be localized into the user's preferred language, a user identity and/or password be assigned for accessing the application, select a hostname/machine identity of a machine the application is allowed to run on (for example, to protect intellectual property), and the like. In a step 310, the installation key may be validated. It is envisioned that, in an embodiment, the validation may be performed by the installer launched in the step 302 (e.g., by utilizing encryption, hash tables, public-private key pairs, and the like).

Alternatively, in an embodiment, the validation may be performed by a remote service. Storing the validation information in a remote service configuration may enhance security in an embodiment. In a step 312, the appropriate components are installed, for example, based on information associated with or contained in the installation key. The components to be installed may reside on a local storage device (such as a CD-ROM) and/or on a remote Internet and/or intranet server such as those discussed with respect to FIG. 1.

In one embodiment, the installation software may be distributed to users (or potential users) free of charge. It is also envisioned that in the step 308 the key may be displayed on the screen to a user which, in turn, may have to enter the key manually into the installation software. In one embodiment, the step 304 may be accomplished by asking a user to call a toll-free number or another appropriate number and discuss the installation options with a customer service or sales associate. One form of captured user data in the step 306 may be geographically based. For example, a user in Chicago may receive map information that is pertinent to the geographical location of that user (i.e. the Chicago vicinity). It is further envisioned that in an embodiment the installer may launch a presentation during the installation through, for example, QuickTime provided by Apple Computers of Cupertino, Calif., and/or Real Player provided by RealNetworks, Inc., of Seattle, Wash.

In a further embodiment, after the installation is complete, the installer software may launch the newly installed application. It is envisioned that in another embodiment if the installer faces an error or detects an error, the installer may launch an error reporting application such as an electronic mail (Email) application to send an Email to the relevant party (e.g., a product support group). In Windows environment, the error reporting application may be the designated/default Email application. The installer may also send a portion of an error log with through the error reporting application (in the case of an Email, as an attachment and/or an inline text message).

In one embodiment of the present invention, it is envisioned that an open application programming interface (API) may be utilized to build an installer. Also, the API may be implemented in the Java programming language. In another embodiment of the present invention, the installation key may have a termination date, i.e., a user will have to utilize the installation key within a certain amount of time (for example ten days).

The foregoing description has been directed to specific embodiments. It will be apparent to those with ordinary skill in the art that modifications may be made to the described embodiments, with the attainment of all or some of the advantages. For example, the techniques of the present invention may be utilized for provision of advertisement, messages, software customization, market research, protection of intellectual property including copyrightable material (e.g., by encrypting the software key, for example, with the hostname of the target machine, so the installed software only runs on that specific machine), and the like. Therefore, it is the object of the appended claims to cover all such variations and modifications as come within the spirit and scope of the invention.

What is claimed is:

1. A method of configuring a software installer, the method comprising:
launching the software installer;
receiving a request to launch a file while the software installer is running;
the software installer accessing an application launch facility to determine a launching command for launching the file;
executing the launching command to obtain an installation key; and
the software installer installing a software product based on data provided by the installation key.

2. The method of claim 1 wherein the installation key includes secured information.

3. The method of claim 1 wherein the secured information is provided by a method selected from a group comprising encryption and provision of public-private key pairs.

4. The method of claim 1 further including cleaning up the launching command prior to the act of executing the launching command.

5. The method of claim 1 wherein the data provided by the installation key includes a version identification of the software product, a duration of accessibility for the software product, a preferred language for the software product, a user identity for the software product, a password for accessing the software product, and a hostname of a machine to have access to the software product.

6. The method of claim 1 wherein the software product is an application.

7. The method of claim 1 wherein the application launch facility is provided by an operating system.

8. The method of claim 7 wherein the operating system is selected from a group comprising Microsoft Windows, HP-UX, IBM-AIX, PALM, UNIX, BSD UNIX, Linux, AUX, Mac OS, and Solaris.

9. The method of claim 1 wherein the installation key includes data that is utilized by the software installer to provide an appropriate set of features for the software product being installed.

10. The method of claim 1 further including capturing user information prior to providing the installation key.

11. The method of claim 10 wherein the captured user information is selected from a group comprising user contact information, operating system in use, and a unique identifying indicia.

12. A method of installing a software application, the method comprising:
launching an application installer to install the software application;
while the application installer is installing the software application, receiving information about a file to launch during the installation of the software application;
determining a launching application that can launch the file;
requesting a launching command from an operating system, the application installer running on the operating system; and
launching the application to open the file.

13. The method of claim 12 wherein the determination of the launching application includes utilizing a registry service.

14. The method of claim 13 wherein the registry service is selected from a group comprising Win32, CDE, and launch services.

15. The method of claim 12 wherein the received file information includes a name of the file.

16. The method of claim 12 wherein the application installer installs the software application on multiple platforms.

17. The method of claim 12 wherein the operating system is selected from a group comprising Microsoft Windows, HP-UX, IBM-AIX, PALM, UNIX, BSD UNIX, Mac OS, Linux, AUX, and Solaris.

18. The method of claim 12 wherein the file is a data file.

19. The method of claim 12 further including cleaning up the launching command prior to launching of the application to open the file.

20. The method of claim 12 further including saving the launching command.

21. The method of claim 20 wherein the launching command is saved prior to the launching of the application to open the file.

22. The method of claim 12 wherein the determination of the launching application includes utilizing an extension of the file.

23. An apparatus for configuring a software installer, the apparatus comprising:
means for launching the software installer;
means for receiving a request to launch a file while the software installer is running;
means for the software installer to access an application launch facility to determine a launching command for launching the file;
means for executing the launching command to obtain an installation key; and
means for the software installer to install a software product based on data provided by the installation key.

24. The apparatus of claim 23 further including means for cleaning up the launching command prior to the act of executing the launching command.

25. The apparatus of claim 23 further including means for capturing user information.

26. An article of manufacture for configuring a software installer, the article comprising:
a machine readable medium that provides instructions that, if executed by a machine, will cause the machine to perform operations including:
launching the software installer;
receiving a request to launch a file while the software installer is running;
the software installer accessing an application launch facility to determine a launching command for launching the file;
executing the launching command to obtain an installation key; and
the software installer installing a software product based on data provided by the installation key.

27. The article of claim 26 wherein the operations further include cleaning up the launching command prior to the act of executing the launching command.

28. The article of claim 26 wherein the operations further include capturing user information.
